(19) United States
(12) Patent Application Publication
(10) Pub. No.: US 2016/0070959 A1
(43) Pub. Date: Mar. 10, 2016

(54) Display System With Imaging Unit, Display Apparatus And Display Method

(71) Applicant: CASIO COMPUTER CO., LTD., Shibuya-ku (JP)

(72) Inventor: Kosuke SUGAMA, Tokyo (JP)

(73) Assignee: CASIO COMPUTER CO., LTD., Shibuya-ku (JP)

(21) Appl. No.: 14/845,115

(22) Filed: Sep. 3, 2015

(30) Foreign Application Priority Data
Sep. 10, 2014 (JP) 2014-183935
Jun. 26, 2015 (JP) 2015-128541

(51) Int. Cl. G06K 9/00; G06T 7/00

(52) U.S. Cl. CPC G06K 9/00369; G06K 9/00778; G06T 7/004; G06T 2207/30242

(57) ABSTRACT

According to one embodiment, a display system includes an imaging unit configured to capture an image of a predetermined area; a determination unit configured to determine a number of persons existing in the area, based on the image captured by the imaging unit; and a selection unit configured to select, in accordance with a determination result in the determination unit, corresponding content data from among a plurality of content data.

### CROSS-REFERENCE TO RELATED APPLICATIONS

This application is based upon and claims the benefit of priority from Japanese Patent Application No. 2014-183935, filed Sep. 10, 2014, and No. 2015-128541, filed Jun. 26, 2015, the entire contents all of which are incorporated herein by reference.

### BACKGROUND OF THE INVENTION

1. Field of the Invention

The present invention relates to a display system that is suited to an environment, such as an exhibition hall, where explanations of individual goods need to be efficiently given, a display apparatus, and a display method.

2. Description of the Related Art

Jpn. Pat. Appln. KOKAI Publication No. 2011-150221 discloses a video output device-equipped apparatus which is configured to project video content on a screen of a human shape or the like, by rear projection, thereby to enhance an impression on a viewer.

In this kind of video output apparatuses including the technique disclosed in Jpn. Pat. Appln. KOKAI Publication No. 2011-150221, preset video content and sound content, which corresponds to the video content, are repeatedly output in a fixed manner.

Taking into account the environment of use of this kind of apparatus, there are a case in which many viewers are present around the apparatus, and a case in which few viewers are present. Thus, when the fixed content is repeatedly reproduced, the output itself of content may become redundant, or, conversely, may become insufficient, depending on the number (large or small) of viewers around the apparatus.

The present invention has been made in consideration of the above circumstances, and the object of the invention is to provide a display system which can always present proper content in accordance with a surrounding environment, a display apparatus, and a display method.

### SUMMARY OF THE INVENTION

In general, according to one embodiment, a projection apparatus comprising: A display system comprising: an imaging unit configured to capture an image of a predetermined area; a determination unit configured to determine a number of persons existing in the area, based on the image captured by the imaging unit; and a selection unit configured to select, in accordance with a determination result in the determination unit, corresponding content data from among a plurality of content data.

### BRIEF DESCRIPTION OF THE DRAWING

FIG. 1 is a view illustrating the configuration of the entirety of a system according to an embodiment of the invention.

FIG. 2 is a perspective view illustrating an external-appearance configuration of a signage apparatus according to the embodiment.

FIG. 3 is a block diagram illustrating a functional configuration of an electronic circuit of the signage apparatus according to the embodiment.

FIG. 4 is a flowchart illustrating the contents of a process of content reproduction which is executed by both the signage apparatus according to the embodiment and a sales support server.

FIG. 5 is a view illustrating an example of goods which are allocated to operation buttons according to the embodiment.

FIG. 6 is a view illustrating an example of crowding level information, which is converted from the number of persons, according to the embodiment.

FIG. 7 is a view illustrating a series of content data for a digital camera, which are read out from a database of the sales support server according to the embodiment.

### DETAILED DESCRIPTION OF THE PREFERRED EMBODIMENT

Hereinafter, referring to the accompanying drawings, a description is given of an embodiment in a case in which the present invention is applied to a signage system used in a store.

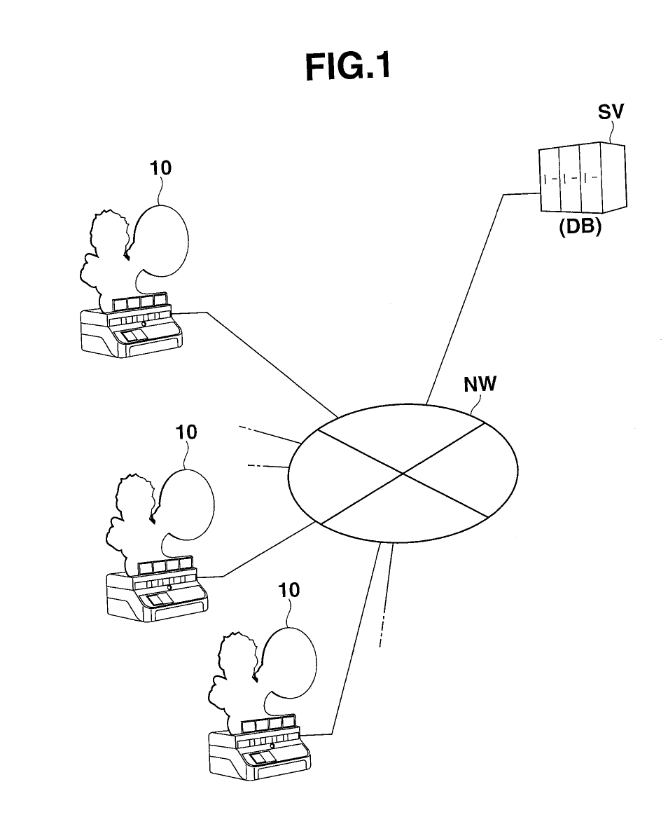

FIG. 1 is a block diagram illustrating a configuration of connection of the entirety of the system. A plurality of signage apparatuses 10 are installed on a store floor. The signage apparatuses 10 are connected to an external sales support server SV via a network NW including a wireless LAN and the Internet.

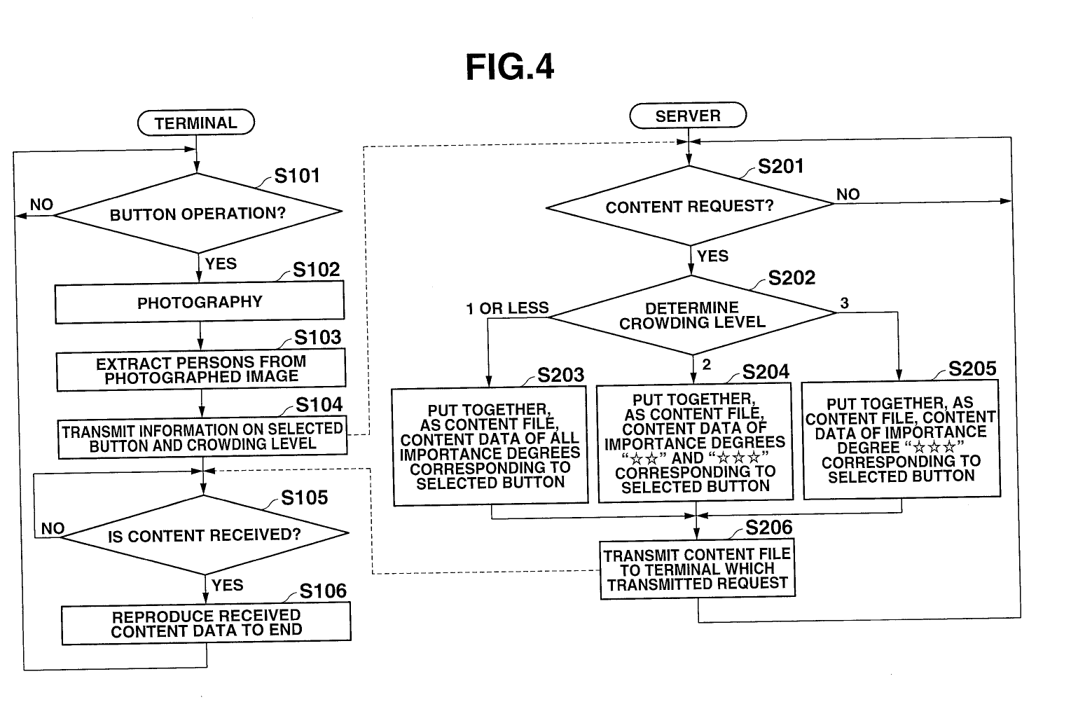

The sales support server SV includes a database (DB) which stores a plurality of content data that are to be reproduced by each signage apparatus 10. The sales support server SV realizes a process (FIG. 4) which will be described later, by a processor (CPU) executing a program.

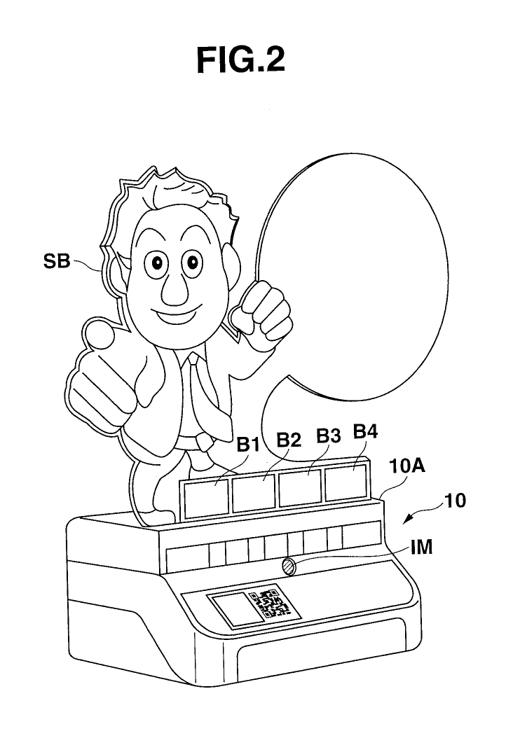

FIG. 2 is a perspective view illustrating an external-appearance configuration of the signage apparatus 10. The signage apparatus 10 is an electronic mannequin using a projector technique. A signage board SB, which is replaceable, is erectly provided on a front end side of the top surface of an apparatus housing 10A. The signage board SB is formed in an arbitrary shape, and is disposed such that the signage board SB is included within a rectangular projectable area. The signage board SB has a semitransparent plate-like configuration.

An optical image that is emitted from a projection lens (not shown) of a rear projection method, which is provided on the top surface of the apparatus housing 10A, is projected from the rear surface side of the signage board SB. Thereby, the signage board SB displays, for example, an image as illustrated in FIG. 2.

A plurality of, or four in this embodiment, operation buttons B1 to B4 are also projected on a lower part of the signage board SB. When any one of the operation buttons B1 to B4 has been touch-operated by the viewer, the touch operation is detected by a line-shaped infrared sensor array which is arranged on a board attachment base portion. The infrared sensors of the infrared sensor array have directivities, respectively, and can detect operation positions on the operation buttons B1 to B4.

In addition, on a front surface of the apparatus housing 10A, there is provided an imaging unit IM of a superwide-angle optical system for photographing an environment on the front surface side of the apparatus housing 10A.

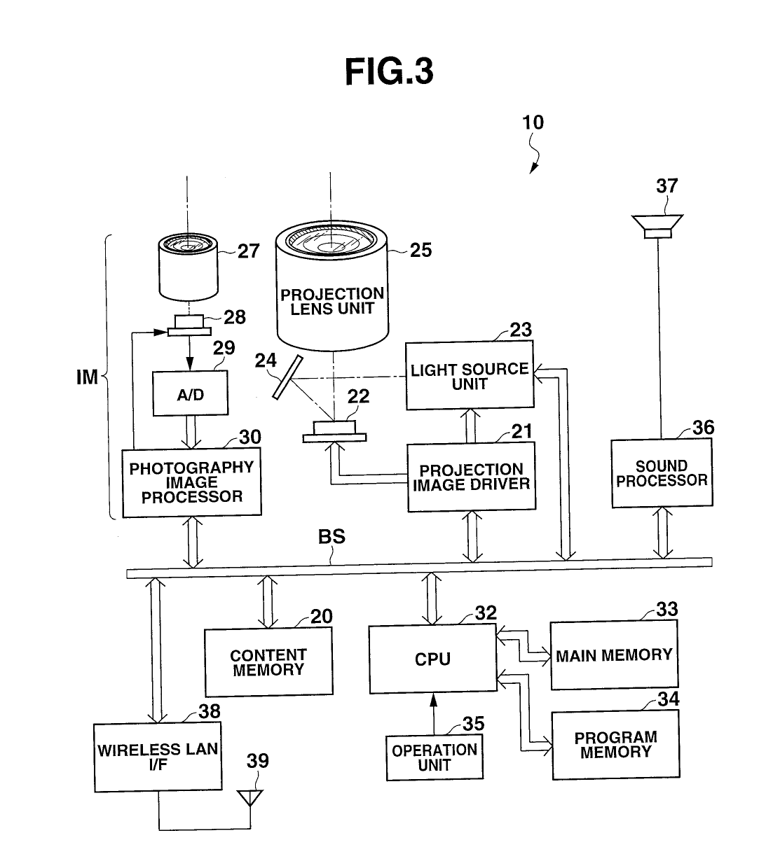

Next, referring to FIG. 3, the functional configuration of, mainly, an electronic circuit of the signage apparatus 10 is described. Content data, which is received from the sales support server SV, is stored in a content memory 20. The content data is composed of image data, sound data, control data, etc. The image data in the content data is read out by a CPU 32 (to be described later), and is sent to a projection image driver 21 via a system bus BS.

The projection image driver 21 drives a micro-mirror element 22 that is a display element, by higher-speed time-division driving with multiplication of a frame rate according to a predetermined format, for example, 120 [frames/sec], the number of division of color components, and the number of display gray levels, in accordance with the image data that was sent.

The micro-mirror element 22 executes a display operation by individually ON/OFF operating at high speed the inclination angles of a plurality of micro-mirrors which arranged in an array, for example, that number of micro-mirrors, which corresponds to WXGA (1280 pixels in horizontal direction×768 pixels in vertical direction), thereby forming an optical image by reflective light from the micro-mirrors.

On the other hand, a light source unit 23 cyclically emits primary-color light of R, G and B in a time-division manner. The light source unit 23 includes an LED which is a semiconductor light-emitting element, and repeatedly emits primary-color light of R, G and B in a time-division manner. The LED, which the light source unit 23 includes, is an LED in a broad sense, and may include an LD (semiconductor laser) or an organic EL element.

In addition, use may be made of primary-color light having a wavelength that is different from the wavelength of the original light, this primary-color light being excited by irradiating a phosphor with the light emitted from the LED. The primary-color light from the light source unit 23 is total-reflected by a mirror 24, and is radiated on the micro-mirror element 22.

Then, an optical image is formed by reflective light from the micro-mirror element 22, and the formed optical image is projected on the back surface of the signage board SB via a projection lens unit 25.

The imaging unit IM includes a superwide-angle photographing lens unit 27 which faces in a frontal direction of the signage apparatus 10, and a CMOS image sensor 28 that is a solid-state image sensing device, which is disposed at an in-focus position of the photographing lens unit 27.

An image signal, which is acquired by the CMOS image sensor 28, is digitized by an A/D converter 29, and then sent to a photography image processor 30.

This photography image processor 30 scan-drives the CMOS image sensor 28, causes the CMOS image sensor 28 to execute a photographing operation, and sends image data, which was acquired by the photographing, as a data file to the CPU 32 (to be described later).

The CPU 32 controls the operations of all the above-described circuits. The CPU 32 is directly connected to a main memory 33 and a program memory 34. The main memory 33 is composed of, for example, an SRAM, and functions as a work memory of the CPU 32. The program memory 34 is composed of an electrically rewritable nonvolatile memory, such as a flash ROM, and stores operational programs which the CPU 32 executes, and various routine data, etc.

The CPU 32 reads out operational programs, routine data, etc., which are stored in the program memory 34, develops and loads them in the main memory 33, and executes the programs, thereby comprehensively controlling the signage apparatus 10.

The CPU 32 executes various projection operations in accordance with operation signals from an operation unit 35. The operation unit 35 accepts key operation signals of some operation keys including a power key, which are provided on the main body of the signage apparatus 10, or accepts detection signals from the infrared sensor array which detects operations on buttons which are virtually projected on a part of the signage board SB. The operation unit 35 sends a signal corresponding to the accepted operation to the CPU 32

The CPU 32 is also connected to a sound processor 36 and a wireless LAN interface (I/F) 38 via the system bus BS.

The sound processor 36 includes a sound source circuit of, for example, a PCM sound source, converts sound data in content data, which is read out from the content memory 20 at a time of a projection operation, to analog data, and drives a speaker unit 37 to produce sound of the analog data or, where necessary, generates a beep or the like.

The wireless LAN interface 38 connects to a nearest wireless LAN router (not shown) via a wireless LAN antenna 39, and executes data transmission/reception. The wireless LAN interface 38 communicates with the sales support server SV shown in FIG. 1.

Next, the operation of the above-described embodiment is described.

FIG. 4 is a flowchart illustrating an operation relating to delivery and reproduction of content, which is executed by the signage apparatus 10 that is a terminal-side apparatus, and the sales support server SV.

The signage apparatus 10 that is the terminal-side apparatus projects an image relating to preset default goods. In this image projection state, the CPU 32 repeatedly determines, based on an input from the operation unit 35, whether an operation is executed on the operation buttons B1 to B4 of the signage board SB (step S101), and stands by until any one of the buttons is operated.

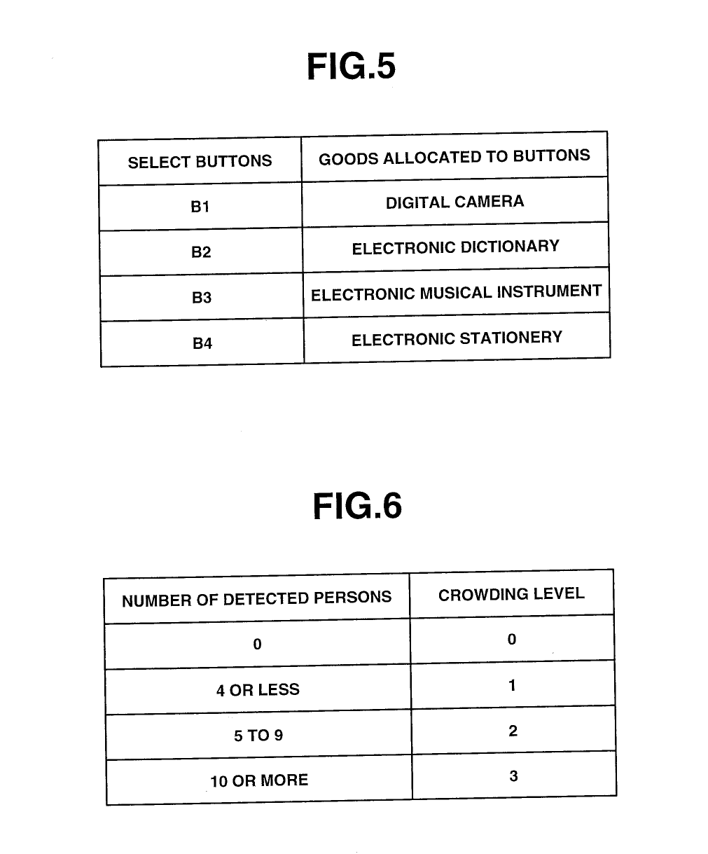

FIG. 5 illustrates an example of goods which are allocated to the operation buttons B1 to B4 of the signage apparatus 10.

When any one of the operation buttons B1 to B4 has been operated by a viewer, the CPU 32 determines that an operation was executed (Yes in step S101). At this time point, the CPU 32 causes the photography image processor 30 of the imaging unit IM to photograph a front-side surrounding of the signage apparatus 10 (step S102).

The photography image processor 30 executes a face recognition process on the image data acquired by this photographing, and extracts face parts of persons from the image. The photography image processor 30 counts the number of face parts of persons, and determines the number of persons existing in the region photographed by the imaging unit IM, based on the counted number. The photography image processor 30 sends a determination result (the number of persons) to the CPU 32 as number-of-persons information (step S103).

Based on the number-of-persons information received from the photography image processor 30, the CPU 32 converts the number-of-persons information to crowding level information which is indicative of a surrounding environment of the signage apparatus 10.

FIG. 6 illustrates an example of the crowding level information which is converted by the CPU 32 based on the number-of-persons information. In FIG. 6, the crowding level is classified into four stages of “0” to “3” in accordance with the number of persons which is indicated by the number-of-persons information.

The CPU 32 combines the crowding level information with the information of any one of the operation buttons B1 to B4, which was accepted in step S101, and adds identification information of the own apparatus to the combined information, thus forming a content data delivery request. The CPU 32 transmits the delivery request to the sales support server SV by the wireless LAN interface 38 and wireless LAN antenna 39 over the network NW (step S104).

Subsequently, the CPU 32 stands by until corresponding content data is sent from the sales support server SV (step S105).

The sales support server SV always stands by for a content data delivery request from each signage apparatus 10 (step S201). At a time point when the sales support server SV has determined that the delivery request was received (Yes in step S201), the sales support server SV determines a crowing level, based on the crowding level information which is added to the delivery request (step S202).

Next, as will be described below, the sales support server SV executes, by a selection unit, a process of selecting content data, which is to be transmitted to the signage apparatus 10, from among a plurality of content data stored in the database, in accordance with the determination result of the crowding level. The sales support server SV realizes the selection unit by a processor executing a program.

To begin with, when the sales support server SV has determined in step S202 that the crowding information is “1” or less, i.e. “0” or “1”, and only viewers, in a range of “0 (zero)” viewer to “4” viewers according to FIG. 6, exist around (in front of) of the signage apparatus 10, the sales support server SV puts together, as a data file, content data of all importance degrees from the database, which correspond to the identification information of the operation button in the delivery request (step S203).

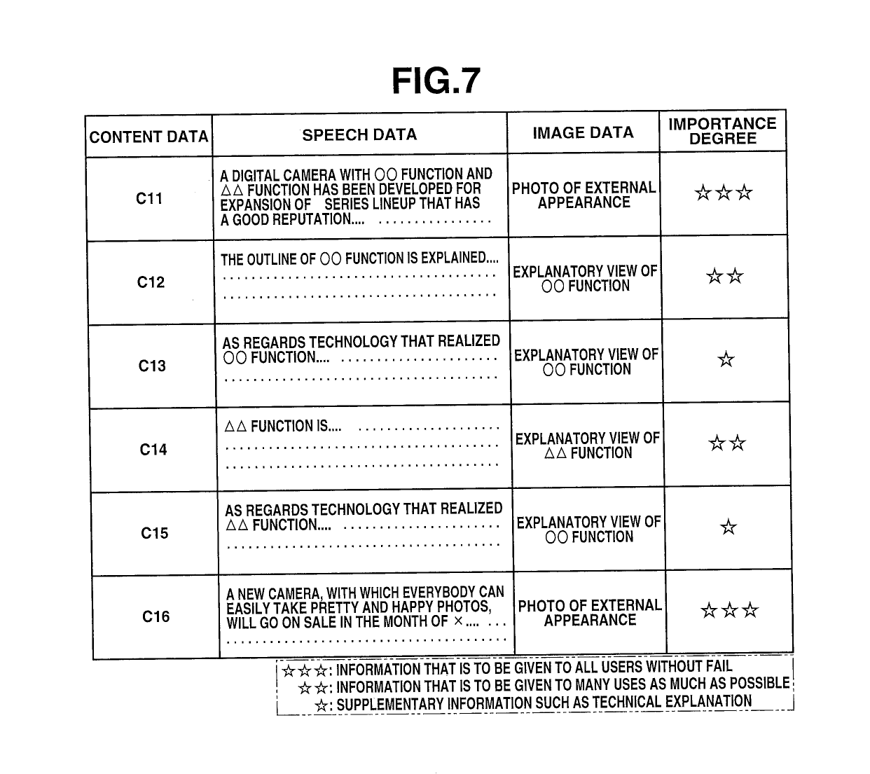

FIG. 7 illustrates a series of content data C11 to C16 for a digital camera, which are prepared in the database of the sales support server SV in accordance with the operation of the operation button B1 in the signage apparatus 10. The series of content data C11 to C16 are composed of a plurality of content data. It is assumed that each of the content data C11 to C16 is composed of sound data, image data and importance degree data. Specifically, an importance degree is added to each content data, C11 to C16.

The importance degree data is set in three stages of “⋆⋆⋆”, “⋆⋆”, and “⋆”. As described in FIG. 7, the importance degree data indicates that the importance of an explanation of associated information to viewers is higher, as the number of star signs “⋆” is larger.

As described above, when the sales support server SV has determined, from the crowding level information, that the number of viewers around (in front of) the signage apparatus 10 is relatively small, the sales support server SV puts together, as a data file, the content data C11 to C16 of all importance degrees.

When the sales support server SV has determined in step S202 that the crowding information is “2”, and “5” to “9” viewers, according to FIG. 6, exist around (in front of) of the signage apparatus 10, the sales support server SV puts together, as a data file, content data of importance degrees “⋆⋆⋆” and “⋆⋆” from the database, which correspond to the identification information of the operation button in the delivery request (step S204).

In this case, as described above, when the sales support server SV has determined, from the crowding level information, that the number of viewers around (in front of) the signage apparatus 10 is relatively medium, the sales support server SV puts together, as a data file, the content data C11, C12, C14 and C16, excluding the content data C13 and C15 of the lowest importance degree “⋆”.

Besides, when the sales support server SV has determined in step S202 that the crowding information is “3”, and “10” or more viewers, according to FIG. 6, exist around (in front of) of the signage apparatus 10, the sales support server SV puts together, as a data file, only content data of the importance degree “⋆⋆⋆” from the database, which correspond to the identification information of the operation button in the delivery request (step S205).

As described above, when the sales support server SV has determined, from the crowding level information, that the number of viewers around (in front of) the signage apparatus 10 is relatively large, the sales support server SV puts together, as a data file, only the content data C11 and C16 of the highest importance degree “⋆⋆⋆”.

After creating the data file of the content data by any one of the processes of steps S203 to S205, as described above, the sales support server SV returns the data file of content data to the signage apparatus 10 which sent the delivery request (step S206). The sales support server SV thus completes the series of processes, and returns to the process of step S201 onwards in preparation for the next delivery request. As described above, the selection unit changes the content data that is to be selected, based on the importance degree.

The signage apparatus 10, which transmitted the delivery request to the sales support server SV, receives the data file of content data as a response from the sales support server SV (Yes in step S105), and causes the memory 20 to store the received content data. Using the image data that constitutes the content data stored in the content memory 20, the signage apparatus 10 projects an image by the projection image driver 21, micro-mirror element 22, light source unit 23, etc. In addition, the signage apparatus 10 causes the sound processor 36 and speaker unit 37 to output sound by using sound data (step S106). At a time point when the signage apparatus 10 has completed the series of image and sound reproduction and output, the signage apparatus 10 returns to the process of step S101 onwards in preparation for content reproduction corresponding to the next button operation, and transitions once again to the state of image projection relating to preset default goods.

As has been described above in detail, according to the present embodiment, proper content can always be presented in accordance with a surrounding environment in which the signage apparatuses 10 are located.

In the above embodiment, the importance degree of content, which corresponds to the number of persons (crowding level), is determined, and the content data to be reproduced is selected in accordance with the importance degree. Therefore, it is possible to exactly present content which is thought to be more important in consideration of the surrounding environment where the signage apparatuses 10 are located.

In particular, in the embodiment, when the number of persons is large, content data with lower importance degrees are omitted in a stepwise manner. Thereby, content with a high importance degree can efficiently be presented to many viewers.

Although not described in the above embodiment, for example, the signage apparatus 10 can vary the output mode of sound content, such as by increasing, in a stepwise manner, the level of sound that is output by the speaker unit 37 in accordance with an increase in the number of persons existing nearby. Thereby, the signage apparatus 10 can always perform more suitable presentation, in addition to varying the output mode of image content.

In the meantime, in the above embodiment, the case was described in which the embodiment was applied to the signage system in which the signage apparatus 10 is connected to the sales support server SV via the network NW. However, by constituting this system, it is possible to provide in real time various sales information with high flexibility, such as recommendable goods, a special offer only at a certain time, and guidance to a sales floor that sells best-selling goods. Moreover, a wide range of applications are possible by making a plurality of signage apparatuses 10 cooperate to guide viewers, or to collect statistics on operational information by viewers and obtain materials for commodity sales promotion.

In addition, in the above-described embodiment, when the signage apparatus 10 receives content data from the sales support server SV, the signage apparatus 10 receives only necessary content among the series of content data C11 to C16, based on the information of the crowding levels (importance degrees) of the series of content data C11 to C16 of the commodity that was selected by the operation of any one of the operation buttons B1 to B4. However, the invention is not limited to this example.

For example, when any one of the operation buttons B1 to B4 was operated by the user, and the content data, which correspond to the commodity allocated to the operation button, B1 to B4, as illustrated in FIG. 5, are received from the sales support server SV, all content data C11 to C16 may be received at a time, regardless of the crowding levels (importance degrees).

On the other hand, the signage apparatus 10 may be used as a stand-alone type apparatus and may be configured to reproduce content data that is selected from among a plurality of prestored content data. Thereby, the signage apparatus 10 can be introduced and installed in a relatively small-scale store, or the like.

Incidentally, in the above-described embodiment, an image of viewers around the signage apparatus 10 is photographed by the imaging unit IM which the signage apparatus 10 includes. However, separately from the apparatus which reproduces content, an imaging device may be provided for capturing an image of the surrounding of the reproducing apparatus.

In the above-described reproduction of content data, there is a case in which a viewer has difficulty in understanding the status of progress of content reproduction, that is, to what extent the reproduction of content has progressed. Thus, a total reproduction time of content and an elapsed time during content reproduction may be visually expressed together with numerical values, etc.

The present invention is not limited to the above-described embodiment. In practice, various modifications may be made without departing from the spirit of the invention. In addition, the functions, which are executed in the above embodiment, may be properly combined and implemented as much as possible. The above-described embodiment includes inventions in various stages, and various inventions can be derived from proper combinations of structural elements disclosed herein. For example, even if some structural elements in all the structural elements disclosed in the embodiment are omitted, if advantageous effects can be obtained, the structure, in which the structural elements are omitted, can be derived as an invention.

In the above-described embodiment, when any one of the operation buttons B1 to B4 was operated by the viewer, the front-side surrounding area of the signage apparatus 10 is photographed at that time point, the number of persons in the photographed image is counted, and the information on the number of persons is converted to the information of the crowding level which is indicative of the surrounding environment of the signage apparatus 10.

However, the timing of photography is not limited to the time when any one of the operation buttons B1 to B4 was operated.

For example, when any one of the operation buttons B1 to B4 was operated by the viewer, the CPU 32 determines that an operation was executed (Yes in step S101) and, at this time point, the CPU 32 causes the photography image processor 30 of the imaging unit IM to photograph the front-side surrounding of the signage apparatus 10 (step S102).

In addition, the signage apparatus 10 receives, from the sales support server SV, content data corresponding to the operation button, B1 to B4, which was operated by the user. At this time, the signage apparatus 10 receives all content data C11 to C16 at a time, regardless of the crowding levels (importance degrees). Then, the CPU 32 counts the number of viewing users by the face recognition function.

If the number of persons, which was first counted, is, for example, four, the CPU 32 determines that the crowding level is 1, as illustrated in FIG. 6, and executes control to reproduce all content data C11 to C16. Thus, the CPU 32 first starts reproduction of content data C11.

Next, the CPU 32 photographs once again, by the photography image processor 30, the front-side surrounding of the signage apparatus 10, after the passing of a predetermined time from reproduction of the content, or immediately before the timing of change of each content data C11 to C16 (i.e. at a time point immediately before the end of reproduction of the content data C11). Specifically, the CPU 32 causes the photography image processor 30 to execute photography at a predetermined timing during the reproduction of the content data.

Then, the CPU 32 counts the number of persons in the photographed image. By this operation, the CPU 32 can count the number of persons who are considered to have been viewing in front of the signage apparatus 10 during the period from the time of operation of the operation button, B1 to B4, to the time point immediately before the end of reproduction of the content data C11.

If the number of persons counted based on the photography after the predetermined time is, for example, ten, the CPU 32 determines that the crowding level is 3, as illustrated in FIG. 6. Although the scheduled content data that is to be reproduced is content data C12, since the crowding level is 3, the CPU 32 switches the reproduction of the content data to the reproduction of only two content data C11 and C16, as illustrated in FIG. 7, and the CPU 32 changes the content data, which is to be next reproduced, to the content data C16.

In this manner, by tracking the persons who were face-recognized and counting the number of persons who have continuously been viewing the content data during the predetermined period from the previous time of photography to the present time of photography, it becomes possible to properly change the length of a series of content data, which is reproduced, in accordance with the number of persons who are viewing the content data.

Thus, instead of continuously reproducing a series of content data corresponding to the initially counted number of viewing persons to the end, the number of persons is counted at each timing when each content data is changed, and the content data that is to be reproduced can properly be changed. Therefore, proper content can always be presented more appropriately in accordance with the surrounding environment.

The present invention is not limited to the above-described embodiment. In practice, various modifications may be made without departing from the spirit of the invention. In addition, the functions, which are executed in the above embodiment, may be properly combined and implemented as much as possible. The above-described embodiment includes inventions in various stages, and various inventions can be derived from proper combinations of structural elements disclosed herein. For example, even if some structural elements in all the structural elements disclosed in the embodiment are omitted, if advantageous effects can be obtained, the structure, in which the structural elements are omitted, can be derived as an invention.

What is claimed is:

1. A display system comprising:
an imaging unit configured to capture an image of a predetermined area;
a determination unit configured to determine a number of persons existing in the area, based on the image captured by the imaging unit; and
a selection unit configured to select, in accordance with a determination result in the determination unit, corresponding content data from among a plurality of content data.

2. The display system of claim 1, wherein the plurality of content data is a series of associated content data,
an importance degree is added to each of the content data, and
the selection unit is configured to change the content data, which is selected, in accordance with the importance degree.

3. The display system of claim 1, further comprising:
a reproduction unit configured to reproduce the corresponding content data,
wherein a timing of imaging by the imaging unit is a time before a start of reproduction of the content data,
the imaging unit is configured to capture the image of the predetermined area at a predetermined timing during reproduction of the content data in the reproduction unit,
the determination unit is configured to determine the number of persons existing in the area, based on an image captured at the predetermined timing, and
the display system further comprises a controller configured to select, when a second importance degree corresponding to a determination result based on the image captured at the predetermined timing is different from a first importance degree corresponding to a determination result based on an image captured before the start of reproduction of the content data, content data corresponding to the second importance degree.

4. The display system of claim 3, wherein the predetermined timing is each time a predetermined time has passed, or a time immediately before changing each content data of a series of content data including the plurality of content data.

5. The display system of claim 1, further comprising:
a storage unit configured to store a plurality of the content data; and
a content output unit configured to output content, based on the content data selected by the selection unit,
wherein the selection unit is configured to select the content data from the storage unit.

6. The display system of claim 5, wherein the storage unit is configured to store the plurality of content data by associating the plurality of content data with information indicative of an importance degree corresponding to a number of persons, and
the selection unit is configured to select content data which the importance degree agrees with, based the determination result in the determination unit.

7. The display system of claim 6, wherein the storage unit is configured to store the plurality of content data by associating the plurality of content data with information indicating that the importance degree is higher when the number of persons is larger, and
the selection unit is configured to omit, in a stepwise manner, selection of content data, which has the importance degree that is lower, from the storage unit, when the number of persons is larger, in accordance with the determination result in the determination unit.

8. The display system of claim 5, wherein the plurality of content data, which the storage unit stores, includes sound data, and
the content output unit is configured to change an output mode of the sound data in accordance with the determination result in the determination unit.

9. A display apparatus comprising:
an imaging unit configured to capture an image of a predetermined area;
a determination unit configured to determine a number of persons existing in the area, based on the image captured by the imaging unit; and
a selection unit configured to select, in accordance with a determination result in the determination unit, corresponding content data from among a plurality of content data.

10. A display method comprising:
capturing a first image of a predetermined area;
determining a first number of persons existing in the area, based on the first image; and
selecting, in accordance with a determination result, corresponding content data from among a plurality of content data.

11. The display method of claim 10, further comprising:
reproducing the corresponding content data;
capturing a second image of the predetermined area at a predetermined timing during reproduction of the content data; and
determining a second number of persons existing in the area, based on the second image,
wherein an importance degree is added to each of the content data, and
selecting, when a second importance degree corresponding to the second number of persons is different from a first importance degree corresponding to the first number of persons, content data corresponding to the second importance degree.

12. The display method of claim 11, wherein the predetermined timing is each time a predetermined time has passed, or a time immediately before changing each content data of a series of content data including the plurality of content data.
